(19) United States
(12) Patent Application Publication
(10) Pub. No.: US 2018/0065416 A1
(43) Pub. Date: Mar. 8, 2018

(54) Tire With A Directional Tread Comprising Alternate Curved Blocks And Grooves

(71) Applicant: COMPAGNIE GENERALE DES ETABLISSEMENTS MICHELIN, Clermont-Ferrand (FR)

(72) Inventors: David MOSNIER, Clermont-Ferrand Cedex 09 (FR); Michel MONTARRAS, Clermont-Ferrand Cedex 09 (FR); Yann HYE, Clermont-Ferrand Cedex 09 (FR)

(21) Appl. No.: 15/551,501

(22) PCT Filed: Feb. 12, 2016
(86) PCT No.: PCT/EP2016/053041

§ 371 Date: Aug. 16, 2017

(30) Foreign Application Priority Data
Feb. 27, 2015 (FR) 1500391

(51) Int. Cl. B60C 11/03; B60C 11/11

(52) U.S. Cl. CPC B60C 11/0302; B60C 2011/0374; B60C 11/11; B60C 11/0309

(57) ABSTRACT

Tire (1) comprising a directional tread (2) comprising a plurality of blocks (5) that are separated by grooves (9), all or some of the blocks (5) of the tread comprising a median sipe (10) of length S, each block comprising a central zone extending generally at an angle β1 such that 35°≦β1≦65° with respect to a transverse direction (Y), an edge zone extending generally at an angle β3 such that 0°≦β3≦10° with respect to the transverse direction (Y), and a joining zone between the central zone and the edge zone, the blocks (5) having a height H and, for two adjacent blocks, the width W of a groove (9) separating these two blocks in their central zone being determined such that H*0.6≦W≦H*0.8.

### TECHNICAL FIELD OF THE INVENTION

The present invention relates to a tire provided with a directional tread that is suitable for wintry conditions involving for example roads covered with ice and/or snow, the tread being provided with a plurality of blocks in the form of curves aligned along the tread.

### PRIOR ART

The document U.S. Pat. No. 4,057,089 describes a tire comprising a tread provided with a plurality of blocks. Each of these blocks is arranged in a curved shape and extends from the centre of the tread to one of the edges. Some blocks are arranged in the shape of a curve in the form of a second degree parabola. The blocks are connected to a central strip. Since the blocks are relatively wide, the stiffness of these same blocks is consequently high, with the result that the tread rapidly becomes worn.

The invention provides various technical means for remedying these various drawbacks.

### SUMMARY OF THE INVENTION

First of all, a first object of the invention consists in providing a tire tread that makes it possible to improve durability.

Another object of the invention consists in providing a tire of which the tread makes it possible to reduce the trapping of stones in the grooves.

Another object of the invention consists in providing a tread that makes it possible to obtain an excellent compromise between grip on snow-covered ground and grip on wet ground, while maintaining the performance on dry ground.

To this end, the invention provides a tire comprising a directional tread, said tread comprising two edges and a centre, this tread comprising a plurality of blocks of height H that are separated by grooves of width W, each block extending continuously along an overall curvature C from one of the edges towards the centre of said tread, forming a block central end, each block having a width WB and a length LB, this width increasing from the block central end in the direction of the edge, all or some of the blocks of the tread comprising a median sipe of length S, said median sipe extending from the block central end along a curvature C′ substantially identical to the curvature C of the block, wherein each block comprises a central zone extending generally at an angle β1 such that 35°≦β1≦65° with respect to a transverse direction (Y), an edge zone extending generally at an angle β3 such that 0°β3β10° with respect to the transverse direction (Y), and a joining zone between the central zone and the edge zone, and wherein, for two adjacent blocks, the width W of a groove separating these two blocks in their central zone is determined such that H*0.6≦W≦H*0.8.

Such an arrangement of the tread makes it possible to considerably reduce the risk of stones becoming trapped in the grooves. The tire furthermore has good endurance characteristics.

Advantageously, the width W of the groove is between 4 mm and 5 mm.

Likewise advantageously, the height H of the blocks is between 6 mm and 8 mm.

Preferably, the width W is 4.5 mm for a value of the block height H of 8 mm.

Advantageously, at least one of the blocks has an inclined wall, said inclined wall making an angle φ with a radial direction such that 5°≦φ≦15°, such that the width W of the groove decreases into the depth of this groove.

According to one advantageous embodiment, the groove comprises a groove bottom, and the tire comprises a protuberance or a plurality of protuberances that protrude from the bottom of this groove, the height of this protuberance being less than one third of the height H of the blocks.

According to another advantageous embodiment, the tire comprises an intermediate layer comprising at least one elastomeric compound, said intermediate layer being under the tread and in contact with a radially inner face of this tread, the intermediate layer having a thickness of between 3 mm and 4 mm. The thickness considered for evaluating the intermediate layer is the mean thickness of this layer along its surface. This layer makes it possible to reduce the risk of cracking on account of stone impacts in the recesses. Any incipient cracks cannot propagate through the rest of the tire. The crown plies are thus protected from any ingress of water that is likely to damage the tire.

In a variant, the tire comprises, under the intermediate layer, a hooping layer in contact with this intermediate layer, the hooping layer comprising parallel reinforcers that are coated in an elastomeric compound, said parallel reinforcers making an angle at most equal to 10° with a circumferential direction of the tire, the thickness of the hooping layer being between 0.8 mm and 1.3 mm. The hooping layer, too, makes it possible to protect the crown layers and makes it possible to reduce the risk of cracking.

According to another advantageous embodiment, the length S of the median sipe is determined such that 0.5·LB≦S≦0.8·LB and the curvature C′ of the median sipe is determined such that the projection ratio Sx/Sy corresponds to 0.5≦Sx/Sy≦1.25, where Sx denotes the projection of the length S of the sipe along a circumferential axis X of the tread and Sy denotes the projection of this length S along a transverse axis Y of the tread.

Such an arrangement makes it possible to obtain an advantageous compromise between the characteristics of grip on snow-covered ground and grip on wet ground without a loss of performance for braking on dry ground. This improvement is due to the coupled effect of the corners created by the sipes and the orientations thereof which have a frictional effect on the snow and thus improve grip. The presence of the sipe and the orientation thereof make it possible to improve the grip on snow-covered ground on account of the corners. Furthermore, the sipe interruption zone makes it possible to increase the stiffness along the axis X and to improve braking on dry ground.

This tire is advantageously provided for all-season use.

According to one advantageous embodiment, all or some of the blocks of the tread comprise a generally circumferential sipe arranged at the opposite end of the median sipe from the block central end, said generally circumferential sipe extending from one edge of the block to the other.

This sipe promotes the flattening of the tire by virtue of the decoupling created. The shoulder stiffness is maintained, however, in order to allow good road holding on cornering.

According to one advantageous embodiment, the circumferential sipe is V-shaped, with the tip forming an angle α of between 100° and 170° and preferably between 150° and 170°. In a variant, the circumferential sipe is in the overall shape of an “S”. In another variant, this sipe may comprise several small segments while maintaining a generally circumferential orientation.

Likewise advantageously, all or some of the blocks of the tread furthermore comprise at least one lateral sipe that is arranged in continuation of the median sipe and decoupled from the latter and from the transverse sipe.

This sipe allows an increase in the number of corners in the shoulder zone and consequently improves braking and driveability on snow-covered roads. Decoupling makes it possible to maintain a degree of stiffness in the block.

According to one advantageous embodiment, the lateral sipe widens from a certain tread-pattern depth, forming a sipe widening, the sipe widening opening onto the shoulder of the tire, beyond the edge of the tread.

This sipe widening makes it possible to extend the favourable characteristics of grip on snow-covered ground in spite of the wear to the blocks, down for example to a block height of around 3 mm. Furthermore, the droplet-shaped profile makes it possible to store water and promotes the performance on wet ground.

According to one advantageous embodiment, at least some of the median sipes comprise a sipe chamfer. The sipe chamfer is advantageously located in the intermediate zone. In a variant, it extends as far as the generally circumferential sipe.

According to another advantageous embodiment, at least some of the blocks are arranged with a block chamfer provided at the trailing edge of the intermediate zone and/or of the edge zone. Preferably, these chamfers are 45°-chamfers with a section of between 1×1 mm and 2×2 mm. They can also be formed by a radius (1 to 2 mm) joined to the faces of the blocks.

According to another advantageous embodiment, at least some of the median sipes comprise stiffening means which connect, for each sipe, the opposite faces of this sipe. The stiffening means are particularly advantageous in the central zone, this zone having the greatest angle with respect to the transverse direction (Y).

The stiffening means are preferably arranged in the sipe at spacings of 5 to 20 mm. The height of the stiffening means is preferably between 40 and 80% of the maximum height of the sipes. Thus, these stiffening means do not extend as far as the surface of the tread when the tire is new.

Advantageously, in at least one sipe, the spacing between the stiffening means is variable.

Likewise advantageously, the stiffening means are integral with the tread.

Likewise advantageously, the blocks are made up of an elastomer composition based on a diene elastomer, a plasticizing system and an interlinking system, wherein the elastomer composition has a glass transition temperature of between −40° C. and −15° C. and a shear modulus G* measured at 60° C. of between 0.5 MPa and 1.1 MPa.

Such a composition allows use under wintry conditions with very cold temperatures without deterioration of the performance.

Furthermore, the Applicants have found, surprisingly, that the tread according to the invention, with an overall appearance of the blocks resembling a summer-type tire, has behavioural characteristics that are particularly advantageous on snow-covered and/or icy ground. The limits of this performance are favourably pushed back further with the use of the above-described compositions.

Furthermore, advantageous improvements in performance are observed when the glass transition temperature of the elastomer composition is between −20° C. and −30° C.

The shear modulus G* is preferably between 0.9 MPa and 1 MPa.

### DESCRIPTION OF THE FIGURES

All the embodiment details are given in the description which follows, which is supplemented by FIGS. 1 to 5, which are given solely by way of non-limiting examples and in which:

FIG. 1 is a schematic depiction of a portion of a tread corresponding substantially to the contact patch;

FIG. 2 is a schematic depiction of a block for a tread such as the one in FIG. 1;

FIG. 3 is a schematic depiction in cross section and in perspective of an example of a groove with an inclined wall between two blocks;

FIG. 4 is a variant embodiment of the arrangement in FIG. 3 with a protuberance at the groove bottom;

FIG. 5 is a schematic depiction in cross section of a portion of the crown region of a tire according to the invention.

### DETAILED DESCRIPTION OF THE INVENTION

### Definitions

In the present document, curved length “L” or “S” means a length measured taking the curvature of the “L”- or “S”-shaped element measured into account.

A “directional tread pattern” means a tread pattern in which the tread pattern elements are specifically arranged to optimize the behavioural characteristics depending on a predetermined sense of rotation. This sense of rotation is conventionally indicated by an arrow on the sidewall of the tire. In such an architecture, the edges of the tread pattern elements which face in the rolling direction are denoted by the term “leading edge”, while the edges of the tread pattern elements which face away from the rolling direction are denoted by the term “trailing edge”. In addition, a “directional tread pattern” is a tread pattern that implies a preferred rolling sense such that, when the tire is rotated in said preferred sense, this tire affords properties of grip on the ground that are better than those afforded when said tire is rotated in the other sense. A directional tread pattern is for example a tread pattern having patterns in the overall shape of a V.

A “sipe” means an elongate and thin (between 0.1 and 2 mm) slit or cutout made in a tread block.

A “median sipe in the block” means that this median sipe separates this block into two generally identical block parts. Since the difference in area between these two block parts is less than 10%, the area is understood to mean that which can come into contact with the ground in the contact patch.

A “lateral sipe” means a sipe which extends generally in the transverse direction Y, the angle formed by the direction of extension of this sipe with the transverse direction Y being less than 15 degrees in absolute terms.

A “lateral sipe decoupled from the median sipe” means that there is an area of rubber between the lateral sipe and the median sipe. The length of this area of rubber is at least 2 mm.

A “circumferential sipe” means a sipe which extends generally in the circumferential direction X, the angle formed by the direction of extension of this sipe with the circumferential direction X being less than or equal to 20 degrees in absolute terms.

The expression “each block extending continuously from one edge 3 towards the centre 4” means that the block is not interrupted by separating grooves that separate this block into different sub-blocks. A groove means a cutout, the material faces of which do not touch under normal rolling conditions. The width of a groove is greater than or equal to 2 mm. Thus, the fact that these blocks are not interrupted by separating grooves makes it possible to improve the evacuation of water from the centre 4 towards the edge 3, the presence of such separating grooves being able to disrupt the flow of water towards the outside of the tire.

The expression “overall curvature C of the block” means that the block has a curved shape. This curvature can be constant or continuously variable. In another variant, the curvature is formed by a succession of segments.

The expression “overall curvature C′ of the median sipe” means that the median sipe follows a curved line. This curvature can be constant or continuously variable. In another variant, the curvature is formed by a succession of segments.

A “tread” means the region of the tire of which at least a part is made to come into contact with the ground and is worn away by this contact with the ground.

### DESCRIPTION OF THE FIGURES

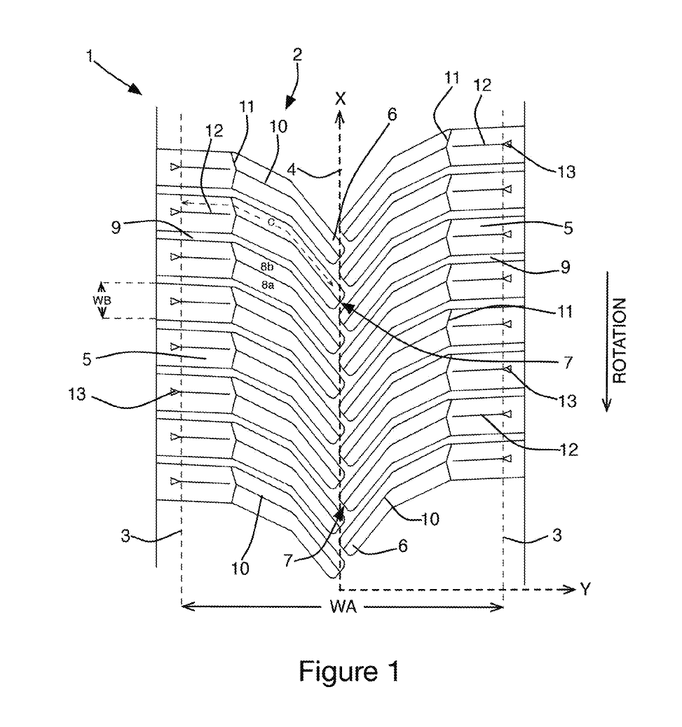

FIG. 1 illustrates substantially the contact patch of a tread 2 of a tire 1. The contact patch has a maximum width WA that is defined by the ETRTO standard and illustrated in FIG. 1 between the dotted lines delimited by the width WA. The ETRTO standard provides a width WA=(1.075-0.005 ar)*S^{1.001} where “ar” is the nominal aspect ratio and S is the theoretical section width on the measuring rim. The lateral edges 3 of the tread correspond to the dotted lines delimiting the width WA.

According to the invention, the tread 2 comprises a plurality of blocks 5. Each of the blocks extends from one edge 3 of the tread towards the central axis 4 of the tread, generally following a curvature C. The expression “towards the centre” means in this case that the block ends in the region of the centre, or just before the centre or just after the centre. The centre 4 is defined by a line that extends in the circumferential direction and divides the tread into two halves. For wide tire sizes, a longitudinal furrow can be added at this centre 4.

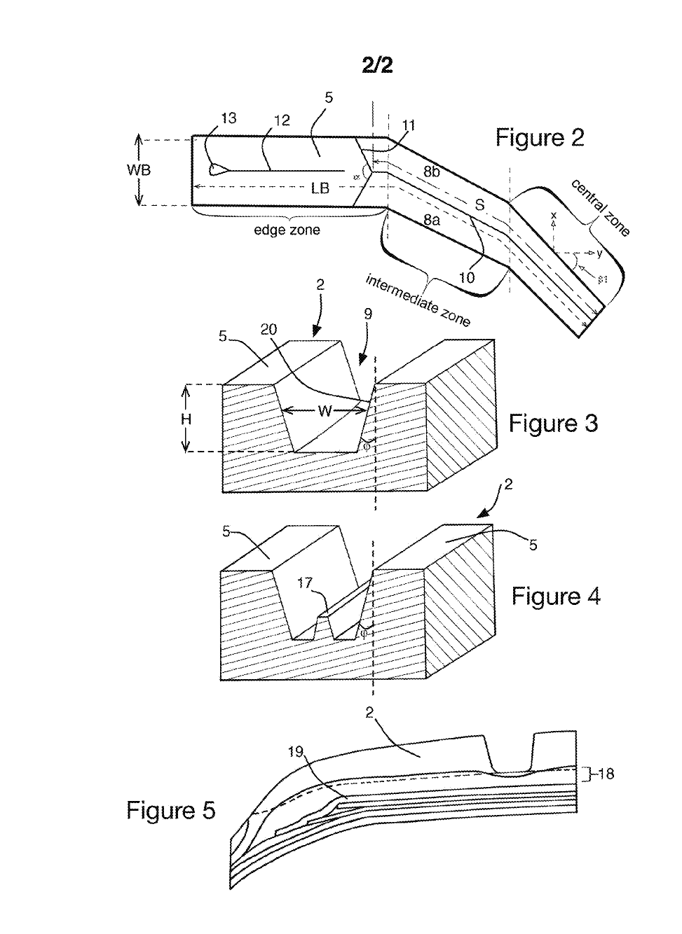

Each of the blocks has a length LB and a width WB, this width increasing from the block central end in the direction of the edge 3. The blocks are advantageously configured in three zones, namely a central zone, an intermediate zone and an edge zone. The central zone makes an angle β1 of between 35° and 65° and more preferably around 50°+−5° with respect to the transverse direction (Y). At the periphery of the blocks, there is the edge zone that makes an angle β3 of between 0° and 10° with respect to the transverse direction (Y). In order to ensure a continuous connection between these two zones, the intermediate zone is provided. This intermediate zone makes it possible to ensure the connection between the central zone and the edge zone with an angle β2 allowing continuity between the three zones. On account of this arrangement in three zones, the blocks have a curvature C, which is progressive from the edge 3 in the direction of the centre 4. In order to shape this curvature, the sides of the blocks form, depending on the case, either a continuous curved line from the edges 3 towards the centre 4, this curvature being able to be variable, or a plurality of angled segments, as shown in FIG. 2. In the case in which a block zone is configured by a succession of segments, the angle β is the mean angle. In the case in which a block zone is configured by a curved segment, the angle β corresponds to the mean of the angles along the curvature.

At least some of the blocks 5 comprise a median sipe 10 that extends along the block along a curvature C′ similar to the curvature C of the block. This sipe makes it possible to separate the block into two parts 8a and 8b, with preferably substantially identical volumes. In a variant, only some of the blocks 5 comprise a median sipe 10.

The median sipe 10 makes it possible to reduce the stiffness of the block 5 by separating it into two half-blocks. The stiffness of each half-block is substantially identical, helping to make the wearing of these two half-blocks uniform. The median sipe 10 has a curved length S. This length S of the median sipe is preferably determined such that 0.5·L≦S≦0.8·L.

According to the invention, at least some of the blocks 5 comprise a generally circumferential sipe 11 arranged at the end of the median sipe 10. The expression “generally circumferential” means an arrangement such that the projection ratio Ry/Rx corresponds to 0≦Ry/Rx≦0.6. This sipe produces a decoupling effect that promotes the flattening of the tire.

The examples in FIGS. 1 and 2 illustrate V-shaped generally circumferential sipes 11, the tip of the V of which makes an angle α of between 100° and 170° and preferably between 150° and 170°. Depending on the embodiment, the tip of the V can be oriented either towards the centre of the tread or towards the proximal edge of the tread. A V-shaped sipe makes it possible to improve grip in the longitudinal and transverse directions.

Finally, the blocks 5 provide at least one lateral sipe 12, which is arranged in the block edge zone. This sipe is offset transversely with respect to the median sipe 10 and the circumferential sipe 11. The offset between this sipe and the other sipes is preferably between 3 and 6 mm. This offset, by locally increasing the stiffness, helps to improve the braking effectiveness on dry ground.

Preferably, this lateral sipe 12 widens from a certain tread pattern depth, forming a sipe widening 13. This sipe widening 13 opens onto the shoulder of the tire and forms a droplet-shaped profile.

Advantageously, the sipes 10 and 12 are arranged at the neutral fibre of the blocks, that is to say so as to separate the blocks into two parts with substantially identical volumes.

The depth of the sipes is preferably between 85% and 105% of the depth of the grooves delimiting the blocks.

FIG. 3 illustrates a schematic depiction in cross section and in perspective of a portion of tread 2 of a tire according to the invention. A circumferential groove 9 makes it possible to separate two adjacent blocks 5. The width W of a groove separating two blocks, in the central zone, is determined such that H*0.6≦W≦H*0.8.

Preferably, this width W is 4.5 mm for a value of the block height H of 8 mm.

At least one of the block walls 20 delimiting the groove 9 is provided at an angle φ with respect to the radial direction. In this example, the two walls 20 delimiting one and the same groove 9 are inclined. The angle φ of the inclined walls is preferably between 6° and 20°. Above 20°, the effect of narrowing of the groove is likely to reduce the performance of water evacuation therefrom.

FIG. 4 is a variant embodiment of FIG. 3 in which a protuberance 17 extends circumferentially along at least a portion of the groove 9. Advantageously, a plurality of protuberances 17 are distributed regularly in the bottom of the groove. The height of the protuberances 17 does not exceed one third of the height H of the blocks.

FIG. 5 shows a cross section of a portion of a crown of a tire according to the invention, in which an intermediate layer 18 is provided under the tread 2 and in contact with a radially inner face of the tread. The intermediate layer comprises at least one elastomeric compound. Its thickness is preferably between 3 mm and 4 mm.

In the example illustrated, a hooping layer 19 is disposed under the intermediate layer 18 and is in contact with this intermediate layer. The hooping layer 19 provides parallel reinforcers that are coated in an elastomeric compound. The reinforcers are aligned substantially in the circumferential direction, that is to say that they form an angle of at most 10° with this direction. The thickness of the hooping layer is between 0.8 mm and 1.3 mm.

The blocks of the tread are made up of an elastomer composition based on a diene elastomer, a plasticizing system and an interlinking system, wherein the elastomer composition has a glass transition temperature of between −40° C. and −15° C. and a shear modulus G* measured at 60° C. of between 0.5 MPa and 1.1 MPa.

The diene elastomer is selected from the group comprising natural rubber, stirene-butadiene rubber, synthetic polyisoprene rubber, polybutadiene rubber and any combinations of these constituents. The plasticizing system comprises plasticizers selected from a plasticizing oil, a plasticizing resin or any combination of these constituents.

The plasticizing resin is a polylimonene resin. The plasticizing oil is selected from a petroleum-based oil, a vegetable oil, or any combination of these oils.

The figures and their descriptions given above illustrate the invention rather than limit it. In particular, the invention and the different variants thereof have just been described in relation to a particular example comprising identical blocks over the entire surface of the tread.

However, it is obvious to a person skilled in the art that the invention can be extended to other embodiments in which, in variants, non-identical blocks are provided either along the circumferential alignment or on either side of the central line of the tread. It is also possible to provide for at least one of the ends of the median sipes 10 to comprise a bridge in the central part of the tread and/or between the median sipe and the circumferential sipe.

The reference signs in the claims are entirely non-limiting. The verbs “comprise” and “have” do not exclude the presence of elements other than those listed in the claims.

### REFERENCE NUMERALS EMPLOYED IN THE FIGURES

1 Tire

2 Tread

3 Tread edge

4 Central axis of tread

5 Block

6 Central end of the block

7 Central end wall of the block

8a Leading-edge part of the block

8b Trailing-edge part of the block

9 Groove

10 Median sipe

11 Generally circumferential sipe

12 Lateral sipe

13 Depthwise sipe widening

17 Protuberance

18 Intermediate layer

19 Hooping layer

20 Block inclined wall

1. A tire comprising a directional tread, said tread comprising two edges and a centre, said tread comprising a plurality of blocks of height H that are separated by grooves of width W, each block extending continuously along an overall curvature C from one of the edges towards the centre of said tread, forming a block central end, each said block having a width WB and a length LB, this width increasing from the block central end in the direction of the edge, all or some of the blocks of the tread comprising a median sipe of length S, said median sipe extending from the block central end along a curvature C′ substantially identical to the curvature C of the block, wherein each said block comprises a central zone extending generally at an angle β1 such that 35°≦β1≦65° with respect to a transverse direction, an edge zone extending generally at an angle β3 such that 0°≦β3≦10° with respect to the transverse direction, and an intermediate zone between the central zone and the edge zone, and wherein, for two adjacent blocks, the width W of a groove separating said two adjacent blocks in their central zone is determined such that H*0.6≦W≦H*0.8.

2. The tire according to claim 1, wherein the width W of the groove is between 4 mm and 5 mm.

3. The tire according to claim 1, wherein the height H of the blocks is between 6 mm and 8 mm.

4. The tire according to claim 1, wherein at least one of the blocks has an inclined wall, said inclined wall making an angle φ with a radial direction such that 5°≦φ≦15°, such that the width W of the groove decreases into the depth of this groove.

5. The tire according to claim 1, wherein, the groove comprising a groove bottom, wherein the tire comprises a protuberance or a plurality of protuberances that protrude from the bottom of this groove, the height of this protuberance being less than one third of the height H of the blocks.

6. The tire according to claim 1, further comprising an intermediate layer, said intermediate layer comprising at least one elastomeric compound, said intermediate layer being under the tread and in contact with a radially inner face of this tread, and wherein the intermediate layer has a thickness of between 3 mm and 4 mm.

7. The tire according to claim 6, comprising, under the intermediate layer, a hooping layer in contact with said intermediate layer, the hooping layer comprising parallel reinforcers that are coated in an elastomeric compound, said parallel reinforcers making an angle at most equal to 10° with a circumferential direction of the tire, and wherein the thickness of the hooping layer is between 0.8 mm and 1.3 mm.
